(19) United States
(12) Patent Application Publication
(10) Pub. No.: US 2026/0093086 A1
(43) Pub. Date: Apr. 2, 2026

(54) LENS BARREL

(71) Applicant: Panasonic Intellectual Property Management Co., Ltd., Osaka (JP)

(72) Inventors: Masayuki NAGAHARA, Osaka (JP); Masayuki SHODAI, Osaka (JP); Takahiro MATSUKAWA, Osaka (JP)

(73) Assignee: Panasonic Intellectual Property Management Co., Ltd., Osaka (JP)

(21) Appl. No.: 19/334,885

(22) Filed: Sep. 21, 2025

(30) Foreign Application Priority Data
Sep. 27, 2024 (JP) 2024-168213

(51) Int. Cl. G02B 7/02; G02B 7/10; G03B 5/00; G03B 17/04; G03B 17/12

(52) U.S. Cl. CPC G02B 7/021; G02B 7/10; G03B 5/00; G03B 17/04; G03B 17/12; G03B 2205/0046

(57) ABSTRACT

A lens barrel 10 includes an exterior unit 15, a front frame unit 12, and a cam/rectilinear unit 13. The exterior unit 15 has a latching portion 15d that is provided on the inner peripheral surface side of a main body portion 15a and is formed facing inward in the radial direction centered on the optical axis of lenses L1 to L8. The front frame unit 12 has a latched portion 12b that is provided so as to extend in the optical axis direction of the main body portion 12a and is elastically deformable in the radial direction centered on the optical axis, and this front frame unit 12 is attached on the inner peripheral surface side of the exterior unit 15 by returning to its initial position when the latched portion 12b elastically deforms and engages with the latching portion 15d. The cam/rectilinear unit 13 is disposed such that the outer peripheral surface of the main body portion 13a is in close proximity to the inner diameter side of the latched portion 12b.

### CROSS-REFERENCE TO RELATED APPLICATIONS

This application claims priority to Japanese Patent Application No. 2024-168213 filed on Sep. 27, 2024. The entire disclosure of Japanese Patent Application No. 2024-168213 is hereby incorporated herein by reference.

### BACKGROUND

### Technical Field

The present disclosure relates to a lens barrel that is attached to a camera body, for example.

### Description of the Related Art

A lens barrel that is attached to an optical device such as a camera body is generally constructed by combining a plurality of substantially cylindrical members.

For example, Patent Literature 1 discloses a lens barrel in which an exterior ring has an elastically deformable locking tongue, which elastically deforms to insert the exterior ring into a front frame, and then the elastic deformation of the locking tongue is released, causing the locking tongue to engage with the front frame and the exterior ring to be attached to the front frame, and furthermore a casing has a protrusion that prevents the locking tongue from elastically deforming in a way that would disengage the front frame from the locking tongue, thereby preventing the exterior ring from coming off the front frame.

### CITATION LIST

### Patent Literature

Patent Literature 1: JP-A 2001-215382

### SUMMARY

### Problem to be Solved by the Invention

However, the following problem is encountered with the above-mentioned conventional lens barrel.

With the lens barrel disclosed in the above publication, it is necessary to provide a shape (projection) for preventing elastic deformation toward the inner diameter side in the form of a separate fixing member.

It is an object of the present disclosure to provide a lens barrel having a simple configuration that includes a tongue (latched portion) that elastically deforms in the radial direction centered on the optical axis, and with which the front frame can be prevented from coming off the fixed frame.

### Means for Solving Problem

The lens barrel according to the present disclosure is a lens barrel that holds a plurality of lenses, and is provided with a fixed frame, a front frame, and a cylindrical member. The fixed frame has a substantially cylindrical first main body portion, and a latching portion that is provided on the inner peripheral surface or outer peripheral surface side of the first main body portion and is formed in the radial direction centered on the optical axis of the lenses. The front frame has a substantially annular second main body portion, and a latched portion that is provided so as to extend in the optical axis direction of the second main body portion and is elastically deformable in the radial direction centered on the optical axis of the lenses, and this front frame is attached to the inner peripheral surface or outer peripheral surface side of the fixed frame by returning to its initial position when the latched portion elastically deforms and engages with the latching portion. The cylindrical member has a substantially cylindrical third main body portion, and the outer peripheral surface or inner peripheral surface of the third main body portion is disposed in close proximity to the inner or outer diameter side of the latched portion.

### Effects

With the lens barrel of the present disclosure, in a configuration including a tongue (latched portion) that elastically deforms in the radial direction centered on the optical axis, a simple configuration can prevent the front frame from coming off the fixed frame.

### BRIEF DESCRIPTION OF THE DRAWINGS

FIG. 1 is an overall oblique view of the configuration of a lens barrel according to an embodiment of the present disclosure;

FIG. 2A is an external oblique view of a state in which the lens barrel in FIG. 1 is in a wide-angle position;

FIG. 2B is an external oblique view showing a state in which the lens barrel in FIG. 1 is in a telephoto position;

FIG. 3 is an exploded oblique view of the components that constitute the lens barrel in FIG. 1;

FIG. 4 is a cross-sectional view of the lens barrel in FIG. 1 in a retracted state;

FIG. 5A is a cross-sectional view showing a state in which the lens barrel in FIG. 1 is in a wide-angle position;

FIG. 5B is a cross-sectional view showing a state in which the lens barrel in FIG. 1 is in a telephoto position;

FIG. 6 is an exploded oblique view of the structure for attaching the front frame unit included in the lens barrel of FIG. 3 to the exterior unit;

FIG. 7 is an oblique view of the structure for attaching the front frame unit in FIG. 6 to the exterior unit;

FIG. 8 is a detail view of the A portion in FIG. 7;

FIG. 9 is a front view of a state in which only the front frame unit has been attached on the inner peripheral surface side of the exterior unit in FIG. 6, as viewed from the subject side in the optical axis direction;

FIG. 10 is a cross-sectional view along the B-B line in FIG. 9;

FIG. 11 is a front view of a state in which the front frame unit and the cam/rectilinear unit have been attached on the inner peripheral surface side of the exterior unit in FIG. 6, as viewed from the subject side in the optical axis direction;

FIG. 12A is a cross-sectional view along the C-C line in FIG. 11, and shows a state in which the outer peripheral surface of the cam/rectilinear unit has been disposed in close proximity to the latching portion where the front frame unit is attached to the exterior unit; and

FIG. 12B is a cross-sectional view along the C-C line in FIG. 11, and shows a state in which the outer peripheral surface of the cam/rectilinear unit has moved away in the optical axis direction from the latching portion where the front frame unit is attached to the exterior unit.

### DETAILED DESCRIPTION OF THE EMBODIMENT

Embodiments will now be described in detail with reference to the drawings as needed. However, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art.

The applicant has provided the appended drawings and the following description so that a person skilled in the art might fully understand this disclosure, but does not intend for these to limit what is discussed in the patent claims.

### Embodiment 1

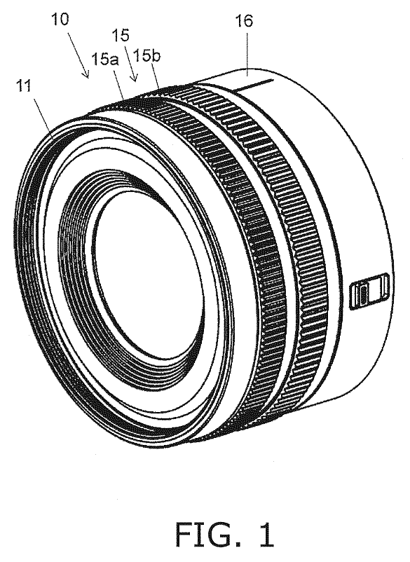

The lens barrel according to an embodiment of the present disclosure will now be described with reference to FIGS. 1 to 12B.

### (1) Overall Configuration of Lens Barrel 10

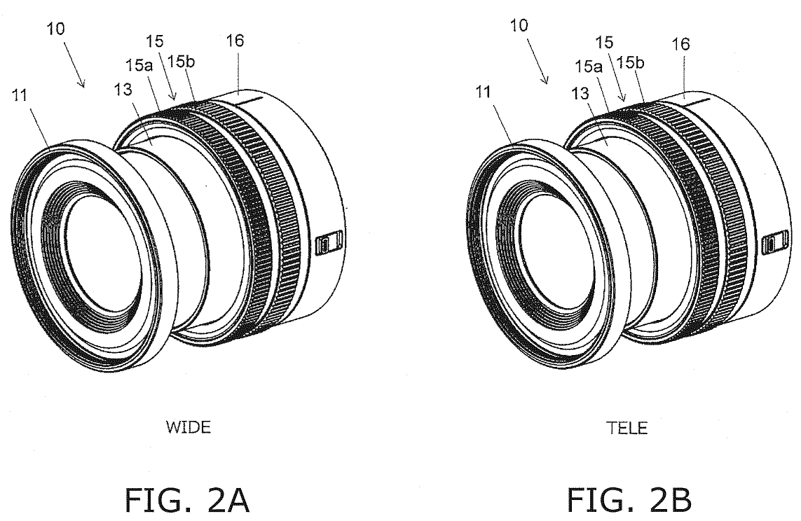

As shown in FIG. 1, the lens barrel 10 according to this embodiment is detachably attached to a camera body (not shown) and captures an image of a subject. The lens barrel 10 captures images with variable magnification by moving a built-in optical system (the plurality of lenses L1 to L8) between the wide-angle side (WIDE side position) shown in FIG. 2A and the telephoto side (TELE side position) shown in FIG. 2B.

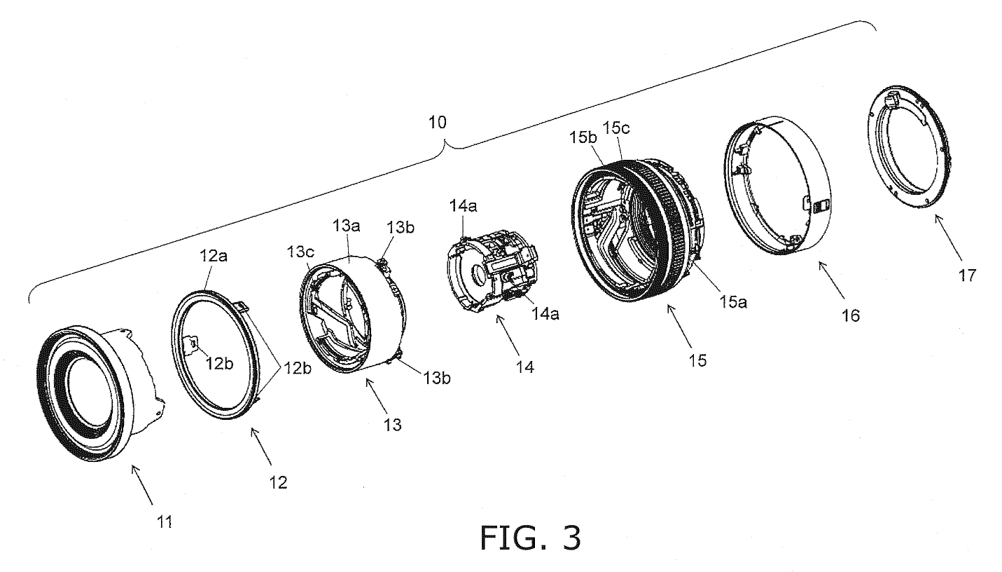

As shown in FIG. 3, the lens barrel 10 includes a first lens group unit 11, a front frame unit (front frame) 12, a cam/rectilinear unit (cylindrical member) 13, a second and third lens group unit 14, an exterior unit (fixed frame) 15, a rear frame unit 16, and a lens mount 17.

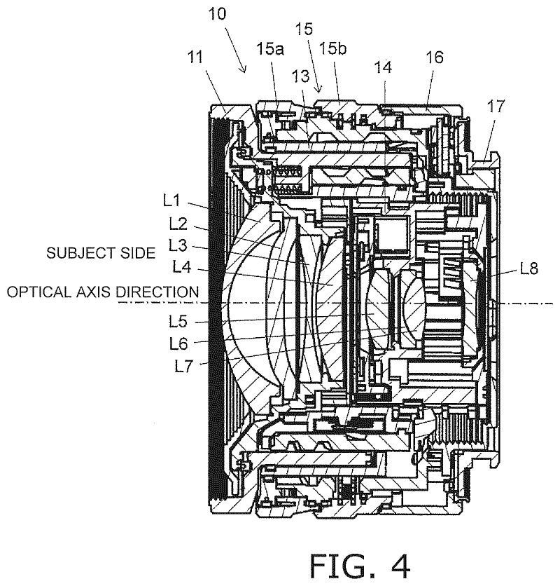

As shown in FIG. 3, the first lens group unit 11 is disposed closest to the subject in the optical axis direction among all the members constituting the lens barrel 10. As shown in FIG. 4, the first lens group unit 11 holds lenses L1 to L4 on the inner peripheral side of the substantially cylindrical shape.

The detailed configuration of the first lens group unit 11 will be described below.

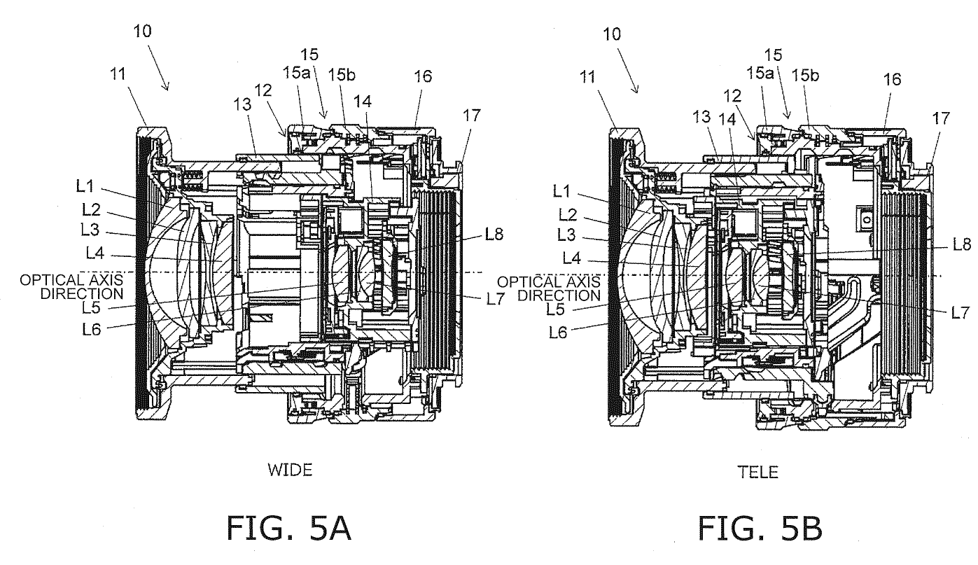

The front frame unit (front frame) 12 is a member that is attached on the subject side of the exterior unit 15 in the optical axis direction, and as shown in FIG. 3, has a substantially annular main body portion (second main body portion) 12a and three latched portions 12b that engage with latching portions 15d provided at substantially equal angular intervals (about 120 degrees) on the inner peripheral surface of the exterior unit 15. As shown in FIGS. 5A and 5B, the front frame unit 12 is provided as an exterior member that is exposed to the outside in the usage state (WIDE position and TELE position).

As shown in FIG. 3, the cam/rectilinear unit (cylindrical member) 13 has a substantially cylindrical main body portion (third main body portion) 13a enveloped on the inner peripheral surface side of the exterior unit 15, three cam followers 13b protruding outward in the radial direction from the outer peripheral surface of the main body portion 13a, and cam grooves 13c formed on the inner peripheral surface side.

The three cam followers 13b engage with cam grooves formed on the inner peripheral surface of the exterior unit 15, and move along the rectilinear grooves formed on the inner peripheral surface of the exterior unit 15 when a zoom ring 15c of the exterior unit 15 is turned.

Consequently, the cam/rectilinear unit 13 moves back and forth in the optical axis direction when the zoom ring 15c of the exterior unit 15 is turned.

As shown in FIG. 3, the second and third lens group unit 14 is a substantially cylindrical member enveloped on the inner peripheral surface side of the exterior unit 15, and holds the lenses L5 to L8 as shown in FIG. 4. The second and third lens group unit 14 has three cam followers 14a that protrude radially outward from its outer peripheral surface.

The three cam followers 14a are engaged with the cam grooves 13c formed on the inner peripheral surface of the cam/rectilinear unit 13. When the zoom ring 15c of the exterior unit 15 is turned, the cam followers 14a move along the cam grooves 13c, causing the second and third lens group unit 14 to move back and forth in the optical axis direction between the WIDE position shown in FIG. 5A and the TELE position shown in FIG. 5B.

As shown in FIG. 3, the exterior unit (fixed frame) 15 has a substantially cylindrical main body portion (first main body portion) 15a that constitutes the exterior of the lens barrel 10, and a focus ring 15b and a zoom ring 15c that are attached to the outer peripheral surface of the main body portion 15a in a state of being rotatable in the circumferential direction around the optical axis.

As shown in FIG. 3, the rear frame unit 16 is a substantially cylindrical member, and is attached so as to cover the outer peripheral surface of the rear end side of the exterior unit 15.

As shown in FIG. 3, the lens mount 17 is a linking member for mounting the lens barrel 10 to a camera body (not shown), and is attached to the end of the exterior unit 15 on the opposite side from the subject in the optical axis direction.

### (2) Structure for Attaching Front Frame Unit 12 to Exterior Unit 15

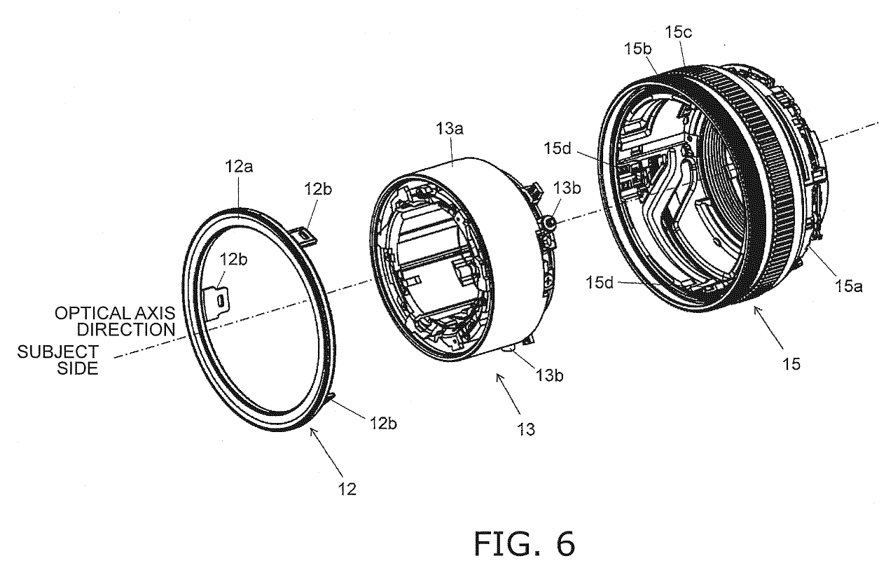

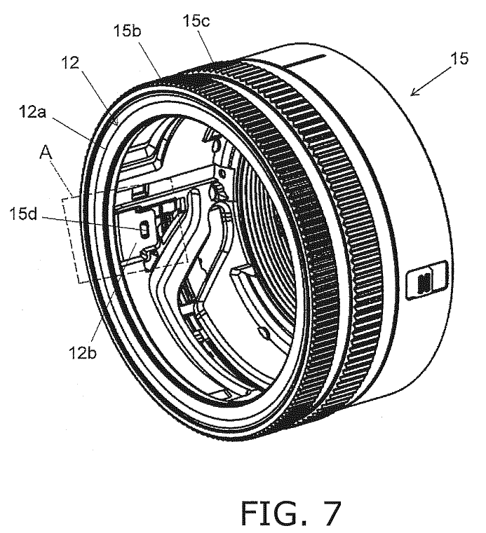

With the lens barrel 10 of this embodiment, as shown in FIG. 6, the cam/rectilinear unit 13 is enveloped on the inner peripheral surface side of the exterior unit 15 in a state of being able to move back and forth in the optical axis direction, and as shown in FIG. 7, the front frame unit 12 is removably attached to the subject side of the exterior unit 15 in the optical axis direction.

As shown in FIG. 6, the front frame unit 12 has a substantially annular main body portion 12a and a latched portion 12b provided to the main body portion 12a.

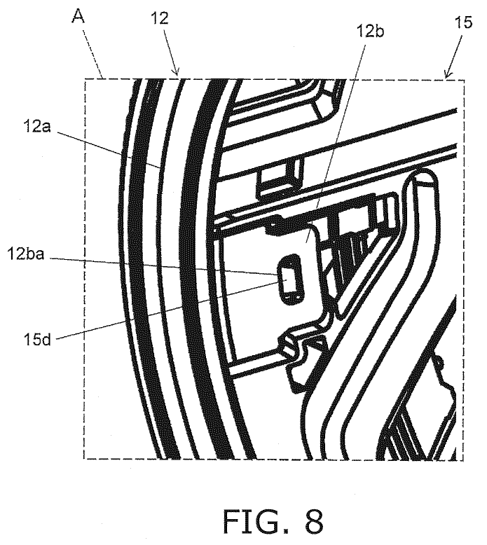

The latched portions 12b are flat portions that are elastically deformable in the radial direction centered on the optical axis of the lenses L1 to L8, and are provided at three locations at approximately equal angular intervals (about 120 degrees) so as to extend from the main body portion 12a in the optical axis direction toward the opposite side from the subject. As shown in FIG. 8, the latched portions 12b each have an opening 12ba near the center of the elastically deformable flat portion.

Consequently, the protruding portions of the latching portions 15d engage with the openings 12ba in the latched portions 12b, thereby attaching the front frame unit 12 to the inner peripheral surface of the exterior unit 15.

Latching portions 15d for attaching the front frame unit 12 are provided on the inner peripheral surface of the exterior unit 15.

The latching portions 15d are provided at three locations at approximately equal angular intervals (about 120 degrees) in the circumferential direction centered on the optical axis, as are the latched portions 12b on the front frame unit 12. As shown in FIG. 8, the latching portions 15d have convex portions that protrude inward in the radial direction centered on the optical axis.

In the A portion of FIG. 7, the front frame unit 12 is attached on the inner peripheral surface side of the exterior unit 15 when the latched portions 12b of the front frame unit 12 are elastically deformed while riding up onto the latching portions 15d and engage with the latching portions 15d of the exterior unit 15, after which the latched portions 12b are restored to their original shape (initial position).

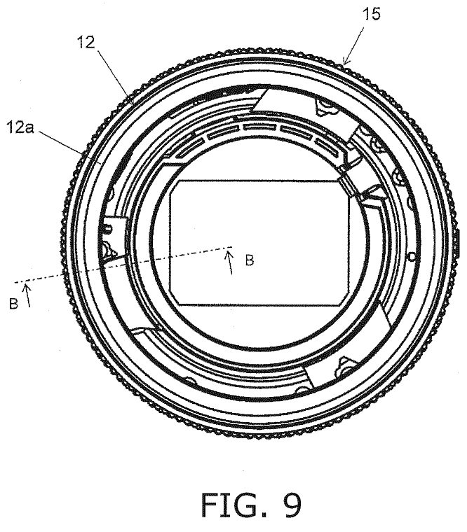

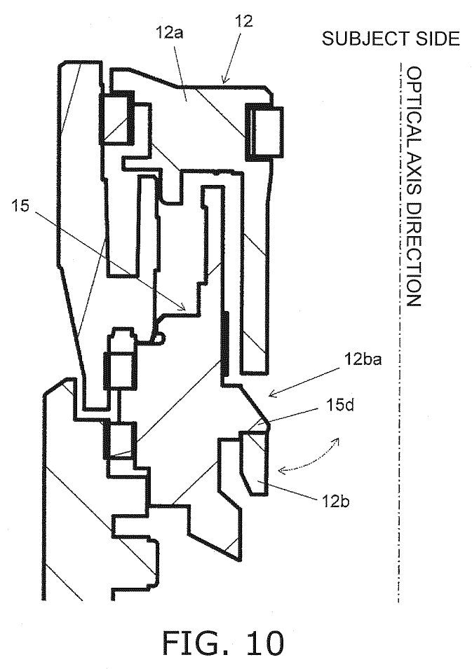

A more detailed description of the mounting structure is given below with reference to FIG. 10, which is a cross-sectional view along the B-B line of the front view (FIG. 9) as seen from the subject side in the optical axis direction in a state in which the front frame unit 12 has been attached to the inner peripheral surface of the exterior unit 15.

That is, as shown in FIG. 10, when the front frame unit 12 is being attached to the inner peripheral surface of the exterior unit 15 from the subject side in the optical axis direction, the latched portions 12b ride up over the latching portions 15d while elastically deforming in the direction of the dashed arrow in the drawing, after which the latching portions 15d engage with the openings 12ba in the latched portions 12b. At this point, the latched portions 12b return to their initial positions shown in FIG. 10, and is latched by the latching portions 15d, thereby attaching the front frame unit 12 to the inner peripheral surface of the exterior unit 15.

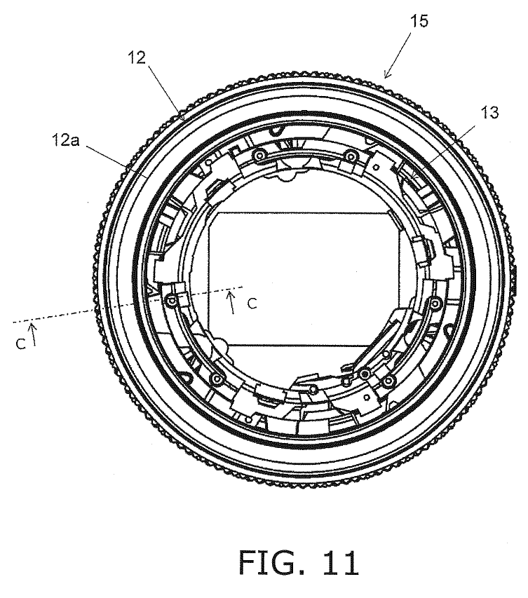

Furthermore, as shown in FIG. 11, the cam/rectilinear unit 13 is disposed on the inner peripheral surface side of the exterior unit 15 to which the front frame unit 12 is attached.

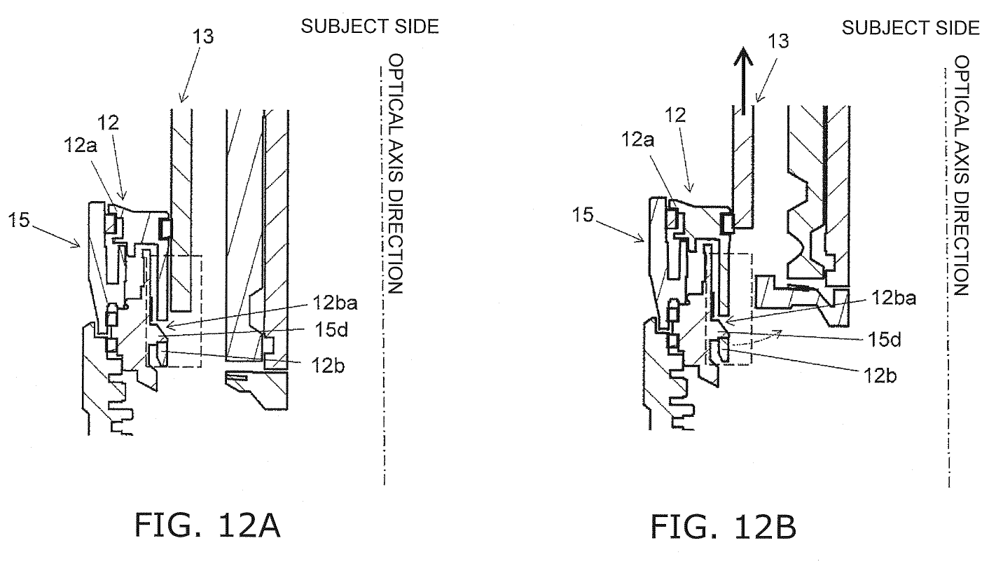

As shown in FIGS. 12A and 12B, the cam/rectilinear unit 13 moves back and forth in the optical axis direction, thereby forming a usage state in which the outer peripheral surface is disposed in close proximity to the latching portions of the front frame unit 12 with respect to the exterior unit 15, and a disassembled state in which the outer peripheral surface is disposed away from the latching portions in the optical axis direction.

More precisely, when the lens barrel 10 is in its usage state (first position), as shown in FIG. 12A, the outer peripheral surface of the cam/rectilinear unit 13 is disposed in close proximity to the portions where the latched portions 12b of the front frame unit 12 are latched to the latching portions 15d of the exterior unit 15.

Here, the term “usage state” means a state in which photography is possible, that is, a state in which the outer peripheral surface of the cam/rectilinear unit 13 is disposed closely in close proximity to positions opposite the latching portions where the latched portions 12b of the front frame unit 12 are latched to the latching portions 15d of the exterior unit 15.

Consequently, in the usage state, the outer peripheral surface of the cam/rectilinear unit 13 prevents the portion of the front frame unit 12 that is latched to the latched portions 12b of the exterior unit 15 from coming loose, making it impossible to attach or detach.

On the other hand, in a state in which the components of the lens barrel 10 are disassembled (second position), as shown in FIG. 12B, the cam/rectilinear unit 13 moves toward the subject in the optical axis direction, causing the latched portions 12b of the front frame unit 12 to enter a state of being able to elastically deform toward the inner diameter side.

Here, the term “disassembled state” means a state in which it is assumed that the front frame unit 12 will be removed from the exterior unit 15, that is, a state in which the outer peripheral surface of the cam/rectilinear unit 13 has moved from a position opposite the latching portion where the latched portions 12b of the front frame unit 12 are latched to the latching portions 15d of the exterior unit 15, to a position that is away from the subject side in the optical axis direction.

Consequently, in the disassembled state, the outer peripheral surface of the cam/rectilinear unit 13 can be retracted in the optical axis direction, and the portion where the latched portions 12b of the front frame unit 12 are latched to the latching portions 15d of the exterior unit 15 can be easily removed and disassembled by inserting a tool or the like on the opposite side from the subject in the optical axis direction, for example.

### Main Features

As shown in FIGS. 12A and 12B, the lens barrel 10 of this embodiment is a lens barrel that holds a plurality of lenses L1 to L8, and includes the exterior unit 15, the front frame unit 12, and the cam/rectilinear unit 13. The exterior unit 15 has the substantially cylindrical main body portion 15a and the latching portions 15d that are provided on the inner peripheral surface side of the main body portion 15a and are formed facing inward in the radial direction centered on the optical axis of the lenses L1 to L8. The front frame unit 12 has the substantially annular main body portion 12a and the latched portions 12b that are provided extending in the optical axis direction of the main body portion 12a and are elastically deformable in the radial direction centered on the optical axis of the lenses L1 to L8. When the latched portions 12b elastically deform and engage with the latching portions 15d, they return to their initial positions, resulting in attachment to the inner peripheral surface side of the exterior unit 15. The cam/rectilinear unit 13 has the substantially cylindrical main body portion 13a, and the outer peripheral surface of the main body portion 13a is disposed in close proximity to the inner diameter side of the latched portions 12b.

Consequently, in order for the front frame unit 12 to come loose from the inner peripheral surface of the exterior unit 15, the latched portions 12b have to elastically deform toward the inner diameter side, but the outer peripheral surface of the cam/rectilinear unit 13 is disposed in close proximity to the inner diameter side of the latched portions 12b, and the latched portions 12b are prevented from elastically deforming toward the inner diameter side.

As a result, in a configuration including the latched portions 12b that elastically deform in the radial direction centered on the optical axis, the front frame unit 12 can be prevented from coming loose from the exterior unit 15.

### OTHER EMBODIMENTS

An embodiment of the present disclosure was described above, but the present disclosure is not limited to or by the above embodiment, and various modifications are possible without departing from the gist of the disclosure.

### (A)

In the above embodiment, an example was given in which the front frame unit 12 (front frame) was inserted and attached on the inner peripheral surface side of the exterior unit 15 (fixed frame). However, the present disclosure is not limited to this.

For example, the configuration may be such that the front frame is attached on the outer peripheral surface side of the fixed frame. In this case, the cam/rectilinear unit (cylindrical member) may be disposed on the outer peripheral surface side of the fixed frame and the front frame.

### (B)

In the above embodiment, an example was given in which the latched portions 12b provided to the front frame unit 12 were formed in a concave shape (as recesses), and the latching portions 15d provided to the exterior unit 15 were formed in a convex shape (as protrusions). However, the present disclosure is not limited to this.

For example, the latched portions on the front frame side may be formed in a convex shape, and the latching portions on the fixed frame side may be formed in a concave shape.

### (C)

In the above embodiment, an example was given in which the latched portions 12b provided to the front frame unit 12 and the latching portions 15d provided to the exterior unit 15 were disposed at three locations at substantially equal angular intervals in the circumferential direction centered on the optical axis. However, the present invention is not limited to this.

For example, the configuration may be such that there is one or two latching portions and one or two latched portions, or there may be four or more of each.

### (D)

In the above embodiment, an example was given in which the lens barrel 10 retracted in two stages, and the outer peripheral surface of the cam/rectilinear unit 13 was disposed in close proximity to the latching portions in order to prevent the front frame unit 12 from coming loose from the exterior unit 15. However, the present disclosure is not limited to this.

For example, in the case of a single-stage retractable lens barrel, the outer peripheral surface of the first lens group unit 11 may be disposed in close proximity to the latching portions to prevent the first lens group unit 11 from coming loose from the fixed frame of the front frame.

### (E)

In the above embodiment, an example was given in which the exterior unit 15 was used as the fixed frame. However, the present disclosure is not limited to this.

For example, some other member included in the lens barrel may be used as the fixed frame.

### (F)

In the above embodiment, an example was given in which the cam/rectilinear unit 13 was used as the cylindrical member. However, the present disclosure is not limited to this.

For example, some ember included in the lens barrel may be used as the cylindrical member.

### (G)

In the above embodiment, an example was given in which the configuration of the present disclosure was applied to the lens barrel 10 that could be attached to and detached from a camera body. However, the present disclosure is not limited to this.

For example, the configuration of the present disclosure may be applied to a lens barrel that is permanently fixed to a camera body.

### (H)

In the above embodiment, an example was given in which the configuration of the present disclosure was applied to the lens barrel 10 that was used after being attached to a camera body, but the present invention is not limited to this.

For example, the configuration of the present disclosure may be applied to a lens barrel that is used in a state of being attached to an optical device other than a camera body.

### Notes

The above description of the embodiments discloses the following techniques.

### Technique 1

The lens barrel according to Technique 1 is:
a lens barrel for holding a plurality of lenses, the lens barrel comprising:
a fixed frame that has a first main body portion with a substantially cylindrical shape, and a latching portion that is provided on a side of an inner peripheral surface or an outer peripheral surface of the first main body portion and is formed in a radial direction centered on an optical axis of the lenses;
a front frame that has a substantially annular second main body portion and a latched portion extending in an optical axis direction of the second main body portion and elastically deformable in the radial direction centered on the optical axis of the lenses, the front frame being attached on the side of the inner peripheral surface or outer peripheral surface of the fixed frame upon returning to its initial position when the latched portion elastically deforms and engages with the latching portion; and
a cylindrical member that has a substantially cylindrical third main body portion, in which the outer peripheral surface or the inner peripheral surface of the third main body portion is disposed in close proximity to an inner diameter side or an outer diameter side of the latched portion.

### Technique 2

The lens barrel according to Technique 2 is the lens barrel according to Technique 1,
wherein the cylindrical member moves back and forth in the optical axis direction.

### Technique 3

The lens barrel according to Technique 3 is the lens barrel according to Technique 1 or 2,
wherein the fixed frame has an operation ring attached on the side of the outer peripheral surface in a rotatable state, and
the cylindrical member is moved in the optical axis direction by turning the operation ring.

### Technique 4

The lens barrel according to Technique 4 is the lens barrel according to Technique 1 or 2,
wherein the cylindrical member covers the entire surface on the inner diameter or outer diameter side of the latched portion at a first position in the optical axis direction, and covers at least part of the surface on the inner diameter or outer diameter side of the latched portion at a second position in the optical axis direction.

### Technique 5

The lens barrel according to Technique 5 is the lens barrel according to Technique 4,
wherein the front frame is detached from the fixed frame by deforming the latched portion toward the inner diameter side in a state in which the cylindrical member is in the second position.

### Technique 6

The lens barrel according to Technique 6 is the lens barrel according to any of Techniques 1 to 5,
wherein the latching portion has a protrusion formed so as to protrude in the radial direction centered on the optical axis.

### Technique 7

The lens barrel according to Technique 7 is the lens barrel according to Technique 6,
wherein the latched portion has a recess that engages with the protrusion of the latching portion.

### Technique 8

The lens barrel according to Technique 8 is the lens barrel according to any of Techniques 1 to 7,
wherein the front frame is disposed at a position exposed to an outside.

### Technique 9

The lens barrel according to Technique 9 is the lens barrel according to any of Techniques 1 to 8,
wherein a plurality of the latching portions and of the latched portions are provided at substantially equal angular intervals in the circumferential direction centered on the optical axis.

### Technique 10

The lens barrel according to Technique 10 is the lens barrel according to any of Techniques 1 to 9,
wherein the front frame is attached on the side of the inner peripheral surface or outer peripheral surface of the fixed frame only by movement in the optical axis direction relative to the fixed frame.

### Technique 11

The lens barrel according to Technique 11 comprises:
a fixed frame;
a front frame that is attached on a side of an inner peripheral surface or an outer peripheral surface of the fixed frame; and
a cylindrical member that has a substantially cylindrical main body portion and an outer peripheral surface and an inner peripheral surface of the main body portion, the cylindrical member having a usage state in which the outer peripheral surface or the inner peripheral surface is disposed in close proximity to a latching portion of the front frame with respect to the fixed frame, and a disassembled state in which the outer peripheral surface or the inner peripheral surface is disposed at a position that is away from the latching portion in an optical axis direction.

### INDUSTRIAL APPLICABILITY

The lens barrel of the present disclosure is equipped with a tongue (latched portion) that elastically deforms in the radial direction centered on the optical axis, and exhibits the effect that the front frame is prevented from coming loose from the fixed frame, and as such can be widely applied to various kinds of lens barrel.

### REFERENCE SIGNS LIST

10 lens barrel
11 first lens group unit
12 front frame unit (front frame)
12a main body portion (second main body portion)
12b latched portion
12ba opening
13 cam/rectilinear unit (cylindrical member)
13a main body portion (third main body portion)
13b cam follower
13c cam groove
14 second and third lens group unit
14a cam follower
15 exterior unit (fixed frame)
15a main body portion (first main body portion)
15b focus ring
15c zoom ring
15d latching portion
16 rear frame unit
17 lens mount
L1 to L8 lenses

What is claimed is:

1. A lens barrel for holding a plurality of lenses, the lens barrel comprising:
a fixed frame that has a first main body portion with a substantially cylindrical shape, and a latching portion that is provided on a side of an inner peripheral surface or an outer peripheral surface of the first main body portion and is formed in a radial direction centered on an optical axis of the lenses;
a front frame that has a substantially annular second main body portion and a latched portion extending in an optical axis direction of the second main body portion and elastically deformable in the radial direction centered on the optical axis of the lenses, the front frame being attached on the side of the inner peripheral surface or outer peripheral surface of the fixed frame upon returning to its initial position when the latched portion elastically deforms and engages with the latching portion; and
a cylindrical member that has a substantially cylindrical third main body portion, in which the outer peripheral surface or the inner peripheral surface of the third main body portion is disposed in close proximity to an inner diameter side or an outer diameter side of the latched portion.

2. The lens barrel according to claim 1,
wherein the cylindrical member moves back and forth in the optical axis direction.

3. The lens barrel according to claim 1,
wherein the fixed frame has an operation ring attached on the side of the outer peripheral surface in a rotatable state, and
the cylindrical member is moved in the optical axis direction by turning the operation ring.

4. The lens barrel according to claim 1,
wherein the cylindrical member covers at least part of a surface on the inner diameter side or the outer diameter side of the latched portion at a first position in the optical axis direction, and moves to a position spaced that is away from the surface on the inner diameter side or outer diameter side of the latched portion at a second position in the optical axis direction.

5. The lens barrel according to claim 4,
wherein the front frame is detached from the fixed frame by deforming the latched portion toward the inner diameter side in a state in which the cylindrical member is in the second position.

6. The lens barrel according to claim 1,
wherein the latching portion has a protrusion formed so as to protrude in the radial direction centered on the optical axis.

7. The lens barrel according to claim 6,
wherein the latched portion has a recess configured to engage with the protrusion of the latching portion.

8. The lens barrel according to claim 1,
wherein the front frame is disposed at a position exposed to an outside.

9. The lens barrel according to claim 1,
wherein a plurality of the latching portions and of the latched portions are provided at substantially equal angular intervals in a circumferential direction centered on the optical axis.

10. The lens barrel according to claim 1,
wherein the front frame is attached on the side of the inner peripheral surface or outer peripheral surface of the fixed frame only by movement in the optical axis direction relative to the fixed frame.

11. A lens barrel, comprising:
a fixed frame;
a front frame that is attached on a side of an inner peripheral surface or an outer peripheral surface of the fixed frame; and
a cylindrical member that has a substantially cylindrical main body portion and an outer peripheral surface and an inner peripheral surface of the main body portion, the cylindrical member having a usage state in which the outer peripheral surface or the inner peripheral surface is disposed in close proximity to a latching portion of the front frame with respect to the fixed frame, and a disassembled state in which the outer peripheral surface or the inner peripheral surface is disposed at a position that is away from the latching portion in an optical axis direction.
